(19) United States
(12) Patent Application Publication
(10) Pub. No.: US 2010/0138080 A1
(43) Pub. Date: Jun. 3, 2010

(54) REMOTE MANAGEMENT OF VEHICLE MODULES BASED ON GEOGRAPHIC LOCATION

(75) Inventors: JOSEPH F. NAZIONE, JR., Macomb, MI (US); SHPETIM S. VELIU, Livonia, MI (US)

Correspondence Address: INGRASSIA FISHER & LORENZ, P.C. (GM), 7010 E. COCHISE ROAD, SCOTTSDALE, AZ, 85253, US

(73) Assignees: GM GLOBAL TECHNOLOGY OPERATIONS, INC., Detroit, MI (US); GENERAL MOTORS CORPORATION, Detroit, MI (US)

(21) Appl. No.: 12/326,501

(22) Filed: Dec. 2, 2008

(51) Int. Cl. G06F 17/00; G01S 1/00

(52) U.S. Cl. 701/2; 342/357.06

(57) ABSTRACT

A method for remotely managing a module of a vehicle includes the steps of determining a position of the vehicle, and implementing a remote management request for the module on the condition that the position of the vehicle is approved for remote management.

### TECHNICAL FIELD

The present invention generally relates to the field of vehicles and, more specifically, to methods and systems for remote management of vehicle modules.

### BACKGROUND OF THE INVENTION

Vehicle manufacturers, dealers, and service centers may desire to manage various vehicle modules under certain situations. For example, vehicle manufactures, dealers, and service centers may desire to manage an engine control unit (ECU) module, a body control module (BCM), and/or various other modules of a vehicle to update software used in connection therewith. Typically, such software updates or other vehicle module management tasks are performed via a wired connection to the vehicle at a repair or service center. However, it may be difficult or inconvenient to bring the vehicle into a repair or service center for such management of the modules thereof.

Accordingly, it is desired to provide methods for remote management of vehicle modules. It is also desired to provide program products for such remote management of vehicle modules. It is further desired to provide systems for such remote management of vehicle modules. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a method for remotely managing a module of a vehicle is provided. The method comprises the steps of determining a position of the vehicle, and implementing a remote management request for the module on the condition that the position of the vehicle is approved for remote management.

In accordance with another exemplary embodiment of the present invention, a program product for remotely managing a module of a vehicle is provided. The program product comprises a program and a computer-readable signal-bearing media. The program is configured to at least facilitate determining a position of the vehicle and implementing a remote management request for the module on the condition that the position of the vehicle is approved for remote management. The computer-readable signal-bearing media bears the program.

In accordance with a further exemplary embodiment of the present invention, a system for remotely managing a module of a vehicle is provided. The system comprises an interface and a processor. The interface is configured to at least facilitate receiving a remote management request for the module. The processor is coupled to the interface, and is configured to at least facilitate determining a position of the vehicle and implementing the remote management request on the condition that the position of the vehicle is approved for remote management.

### DETAILED DESCRIPTION OF DRAWINGS

The present invention will hereinafter be described in conjunction with the following drawing figures, wherein like numerals denote like elements, and wherein:

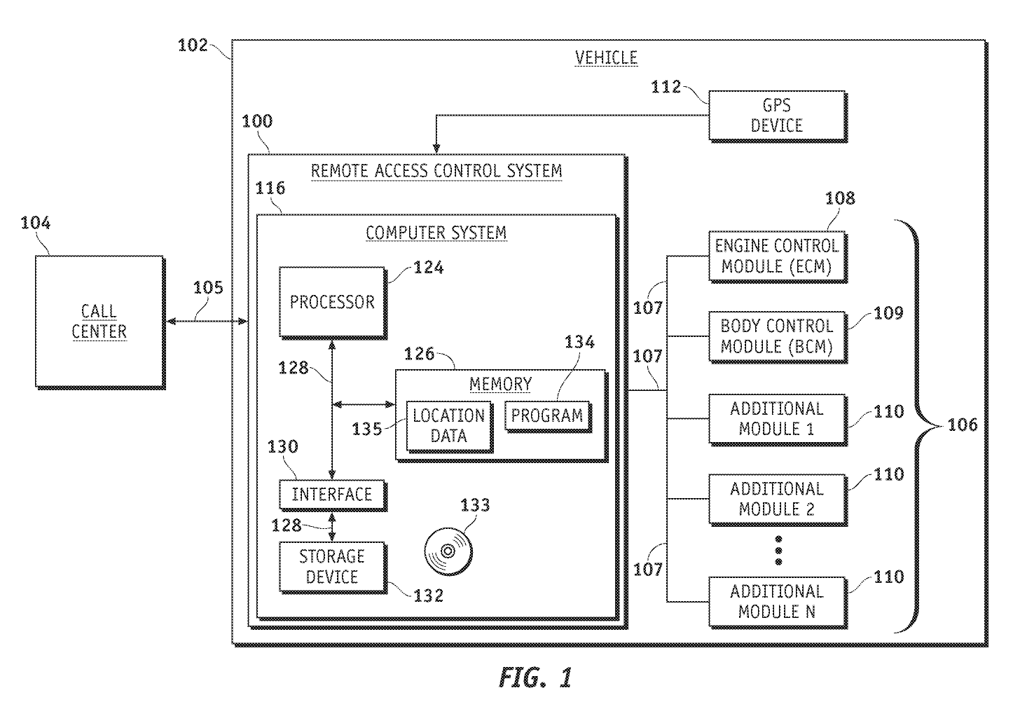

FIG. 1 is a functional block diagram showing a system for controlling remote management of a module of a vehicle in accordance with an exemplary embodiment of the present invention; and

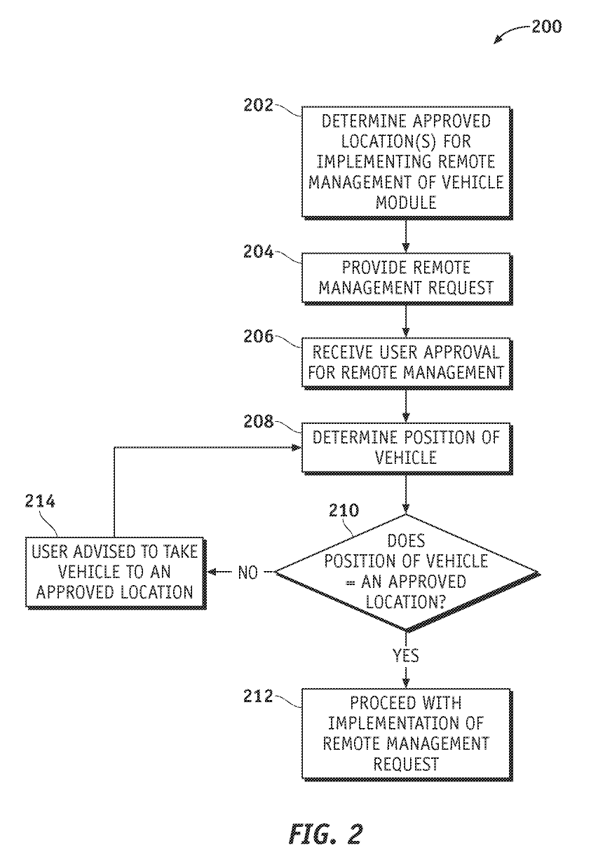

FIG. 2 is a flowchart of a process for controlling remote management of a module of a vehicle that can be implemented in connection with the system of FIG. 1 in accordance with an exemplary embodiment of the present invention.

### DETAILED DESCRIPTION OF AN EXEMPLAR EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

FIG. 1 is a functional block diagram showing a remote management control system 100 in a vehicle 102 in accordance with an exemplary embodiment of the present invention. Specifically, the remote management control system 100 selectively permits a call center 104 or other authorized user to remotely manage, such as through a wireless network 105, one or more modules 106 of the vehicle 102. In the depicted embodiment, the modules 106 of the vehicle 102 for which remote access may be sought include an engine control unit (ECM) module 108, a body control module (BCM), and/or various other additional modules 1 10. For example, the additional modules 110 may include a braking module, a transmission module, a steering wheel module, an air conditioning module, a radio module, and/or any number of other types of vehicle modules. As shown in FIG. 1, in this embodiment the various vehicle modules 106 are networked together, and to the remote management control system 100, via a vehicle bus 107. Such remote access can be permitted via, for example, any one of a number of different types of wireless networks known in the art. In a preferred embodiment, the remote management control system 100 and the computer system 116 are disposed in an FCP/telematics unit of the vehicle 102. However, this may vary in other embodiments.

In the depicted embodiment, the remote management control system 100 includes a computer system 1 16. The computer system 116 receives a remote management request for one or more of the modules, obtains a position of the vehicle 102 (for example, as determined by the call center 104 based as a latitudinal/longitudinal address based upon raw GPS data provided by the GPS device 112), and implements the remote management request on the condition that the position of the vehicle 102 is pre-approved for remote management. In so doing, the computer system 116 preferably implements steps of a control process such as the exemplary remote management control process for controlling remote management of vehicle modules depicted in FIG. 2 and described further below in connection therewith. As referenced herein, the position of the vehicle may refer to a physical or geographic location of the vehicle, such as a longitudinal and latitudinal address, and/or another type of position of the vehicle.

In the depicted embodiment, the computer system 116 includes a processor 124, a memory 126, a computer bus 128, an interface 130, and a storage device 132. The processor 124 performs the computation and control functions of the remote management control system 100, and may comprise any type of processor or multiple processors, single integrated circuits such as a microprocessor, or any suitable number of integrated circuit devices and/or circuit boards working in cooperation to accomplish the functions of a processing unit.

During operation, the processor 124 executes one or more programs 134 preferably stored within the memory 126 and, as such, controls the general operation of the computer system 116. Specifically, the processor 124 receives a remote management request for one or more of the modules, determines a position of the vehicle 102, and implements the remote management request on the condition that the position of the vehicle 102 is pre-approved for remote management.

In so doing, the processor 124 preferably executes the steps of a control process such as the exemplary process for controlling remote access depicted in FIG. 2 and described further below in connection therewith. The processor 124 determines the position of the vehicle 102 based at least in part on the information. In one such embodiment, the processor 124 receives information pertaining to a longitude and latitude of the position of the vehicle 102 from a global positioning system (GPS) device 112, such as that depicted in FIG. 1, and determines the position of the vehicle 102 based on this information. However, in other embodiments this may vary in other embodiments. For example, in certain embodiments, a user may enter information pertaining to the location of the vehicle 102 via the interface 130.

Also in a preferred embodiment, the processor 124 is further configured to implement a software update (preferably obtained from the call center 104 via the network 105) for one or more of the vehicle modules 106 on the condition that the position of the vehicle 102 is approved for remote management. In addition, in a preferred embodiment, the processor 124 is further configured to determining a plurality of pre-approved locations for remote management based at least in part on one or more of the following: historical data pertaining to driving of the vehicle 102, parking of the vehicle 102, or both, or a place of residence, a place of work, and/or a place of vacation of a user of the vehicle 102, and to implement the remote management request on the condition that the position of the vehicle 102 comprises one of the plurality of pre-approved locations. However, this may vary in other embodiments.

In certain other embodiments, the call center 104 may determine the position of the vehicle 102 based on information obtained from the vehicle 102 and/or from the GPS device 112. In some such embodiments, the call center 104 may determine whether the position of the vehicle 102 is approved for remote management. In addition, in some such embodiments, the call center 104 may provide the remote management request to the vehicle 102 and/or to the remote management control system 100 only upon the condition that the position of the vehicle 102 is approved for remote management.

Also, in certain embodiments, the remote management request is intended for a geographic region, and the processor 124 is further configured to implement the remote management request on the condition that the position of the vehicle 102 is within the geographic region. For example, in certain embodiments, a software upgrade for a vehicle module 106 may be rolled out on a trial basis in a limited geographic area. In certain other embodiments, a software upgrade for a vehicle module 106 may be tailored to vehicles in geographic regions with certain temperatures, weather conditions, time, other environmental conditions, and/or other driving conditions. However, this may also vary in other embodiments.

The memory 126 stores a program or programs 134 that executes one or more embodiments of a remote management control process of the present invention, such as the remote management control process depicted in FIG. 2 and described further below in connection therewith. In addition, in one preferred embodiment, the memory 126 also stores location data 135. The location data 135 preferably includes a listing of one or more pre-approved locations for performing remote management of one or more of the vehicle modules 106. In certain other embodiments, the location data 135 may be stored elsewhere, for example in the call center 104.

In certain preferred embodiments, such approved locations include a place of residence, a place of vacation, and/or a place of business of an owner or operator of the vehicle 102, or another location in which the vehicle 102 is likely to remain for at least an amount of time necessary to perform the remote management. This helps to ensure that such remote management is not interrupted by, and/or does not interrupt, a vehicle owner or operator's desire to operate the vehicle 102.

In certain other preferred embodiments, other criteria may be utilized for the approved locations. For example, if software upgrades are intended only for certain geographic regions, then the pre-approved locations may comprise locations within such geographic regions. It will be appreciated that various other criteria may also be used.

The memory 126 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 126 may be a single type of memory component, or it may be composed of many different types of memory components. In addition, the memory 126 and the processor 124 may be distributed across several different computers that collectively comprise the computer system 116. For example, a portion of the memory 126 may reside on a computer within a particular apparatus or process, and another portion may reside on a remote computer.

The computer bus 128 serves to transmit programs, data, status and other information or signals between the various components of the computer system 116. The computer bus 128 can be any suitable physical or logical means of connecting computer systems and components. This includes, but is not limited to, direct hard-wired connections, fiber optics, and infrared and wireless bus technologies.

The interface 130 allows communication to the computer system 116, for example from a system operator and/or another computer system, and can be implemented using any suitable method and apparatus. It can include one or more network interfaces to communicate to a call center 104 or other authorized user, other systems or components, one or more terminal interfaces to communicate with technicians, and one or more storage interfaces to connect to storage apparatuses such as the storage device 132. As mentioned above, in certain embodiments, the interface 130 may also be utilized to obtain information pertaining to the position of the vehicle 102. In addition, in certain embodiments, a human machine interface, such as a radio display located outside the remote access control system 100 but within the vehicle 102, may be utilized to request that a user or owner of the vehicle 102 move the vehicle 102 to a pre-approved location.

The storage device 132 can be any suitable type of storage apparatus, including direct access storage devices such as hard disk drives, flash systems, floppy disk drives and optical disk drives. In one exemplary embodiment, the storage device 132 comprises a program product from which memory 126 can receive a program 134 that executes one or more embodiments of a remote management control process of the present invention. In one preferred embodiment, such a program product can be implemented as part of, inserted into, or otherwise coupled to the remote management control system 100. As shown in FIG. 1, the storage device 132 can comprise a disk drive device that uses disks 133 to store data. In other embodiments, software updates and/or other data may be transmitted to a radio within the vehicle and/or another device via the vehicle bus 107 and stored within such radio and/or other device. As one exemplary implementation, the computer system 116 may also utilize an Internet website, for example for permitting or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 133), and transmission media such as digital and analog communication links. It will similarly be appreciated that the remote management control system 100 may also otherwise differ from the embodiment depicted in FIG. 1, for example in that the remote management control system 100 may be coupled to or may otherwise utilize one or more remote computer systems and/or other control systems.

FIG. 2 is a flowchart of an exemplary embodiment of a remote management control process 200 for controlling remote management of one or more modules of a vehicle, and that can be implemented in connection with the remote management control system 100 of FIG. 1, in accordance with an exemplary embodiment of the present invention.

As shown in FIG. 2, the remote management control process 200 includes the step of determining one or more approved locations for implementing remote management of one or more vehicle modules (step 202). In one preferred embodiment, the one or more approved locations are determined by the processor 124 of FIG. 1 and are then stored in the memory 126 of FIG. 1 as the location data 135 of FIG. 1 for subsequent retrieval and use by the processor 124. In another preferred embodiment, the one or more approved locations are determined by the call center 104 of FIG. 1 and stored therein for future use.

Also in a preferred embodiment, the one or more approved locations represent locations that are pre-approved for remote management based at least in part on one or more of the following: historical data pertaining to driving of the vehicle, parking of the vehicle, or both. In certain preferred embodiments, such approved locations may include a place of residence, a place of business, and/or a place of vacation of an owner or operator of the vehicle, or another location in which the vehicle is likely to remain for at least an amount of time necessary to perform the remote management. This helps to ensure that such remote management is not interrupted by, and/or does not interrupt, a vehicle owner or operator's desire to operate the vehicle.

In certain other preferred embodiments, other criteria may be utilized for the approved locations. In certain embodiments, if software upgrades are intended only for certain geographic regions, then the pre-approved locations may comprise locations within such geographic regions. For example, in certain embodiments, a software upgrade for a vehicle module may be rolled out on a trial basis in a limited geographic area. In certain other embodiments, a software upgrade for a vehicle module may be tailored to vehicles in geographic regions with certain temperatures, weather conditions, time, other environmental conditions, and/or other driving conditions. It will be appreciated that various other criteria may also be used.

In addition, a remote management request is received (step 204). In a preferred embodiment, the remote management request pertains to a software update or upgrade and/or one or more other updates, upgrades, repairs, monitoring, and/or servicing of one or more of the vehicle modules 106 of FIG. 1. Also in a preferred embodiment, the remote management request is received from the call center 104 of FIG. 1 by the interface 130 of FIG. 1 via the network 105 of FIG. 1.

However, this may vary in other embodiments. For example, in certain embodiments, the remote management request is received by the vehicle during implementation of the remote management request in step 212 below. That is, in such embodiments, the call center 104 of FIG. 1 may delay sending the remote management request to the vehicle until it has determined that the vehicle is ready for implementing (and is in an appropriate location for implementing) the remote management request.

In certain embodiments, user approval for remote management is received (step 206). In one preferred embodiment, a vehicle owner or user is given an opportunity to approve remote management via the interface 130 of FIG. 1, and the process proceeds to step 208 below only once such approval has been granted. In certain other embodiments, step 206 may not be necessary.

Also, a position of the vehicle is determined (step 208). In a preferred embodiment, the position of the vehicle is determined by the processor 124 of FIG. 1 based upon information obtained from the global positioning system (GPS) device 112 of FIG. 1. However, in other embodiments this may vary. For example, in certain embodiments, a user may enter information pertaining to the location of the vehicle via the interface 130. In yet other embodiments, the call center 104 of FIG. 1 may determine the position of the vehicle based on information obtained from the vehicle 102 and/or from the GPS device 112 of FIG. 1.

A determination is then made as to whether the position of the vehicle is an approved location for remote vehicle module management (step 210). Specifically, a determination is made in step 210 as to whether the vehicle position determined in step 208 is one of a plurality of pre-approved locations determined in step 202, in accordance with one exemplary embodiment of the present invention.

Also in one exemplary embodiment, this determination is made by the processor 124 of FIG. 1 by retrieving the list of the pre-approved locations from the location data 135 of FIG. 1 from the memory 126 of FIG. 1 and comparing the list to the position of the vehicle obtained in step 208, to determine whether a longitude and latitude of the position of the vehicle represents one of the pre-approved locations represented in the location data 135. In another exemplary embodiment, this determination is made by the call center 104 of FIG. 1 based on location data stored within and/or otherwise obtained by the call center 104.

If it is determined in step 210 that the position of the vehicle is an approved location for remote vehicle module management, then the remote management request is implemented (step 212). For example, in one preferred embodiment, one or more software upgrades or updates of one or more of the vehicle modules 106 of FIG. 1 are executed by the processor 124 of FIG. 1. In other embodiments, various other different types of remote management of one or more of the vehicle modules 106 are permitted. Also in a preferred embodiment, such remote management is conducted by the call center 104 of FIG. 1 via the network 105 of FIG. 1, as permitted by the processor 124 of FIG. 1.

However, this may also vary in other embodiments. For example, in certain embodiments, the implementation of the remote management request may solely be conducted by the call center 104 of FIG. 1. In one such embodiment, the call center 104 may provide the remote management request to the vehicle 102 of FIG. 1 and/or to the remote management control system 100 of FIG. 1 only upon the condition that the position of the vehicle is approved for remote management. For example, in one such embodiment, the implementation of the remote management request in step 214 includes the transmission of the remote management request itself along with the implementation thereof, rather than having the transmission of the remote management request provided in a separate step of the process.

Conversely, if it is determined in step 210 that the position of the vehicle is not an approved location for remote vehicle module management, then the remote management request is not implemented, and instead the vehicle owner or user is advised to take the vehicle to an approved location for remote vehicle module management (step 214). For example, in one preferred embodiment, the requested remote vehicle management is disallowed by the processor 124 of FIG. 1, and the processor 124 instead provides such instructions via the interface 130 of FIG. 1 for the owner or user of the vehicle to move the vehicle to one of the approved locations determined in step 202 above, if it is determined in step 210 by the processor 124 that the position of the vehicle is not one of the pre-approved locations for remote vehicle module management as determined in step 202 above and reflected in the location data 135 stored in the memory 126 of FIG. 1.

However, this may vary in other embodiments of the present invention. For example, in another preferred embodiment, the call center 104 only provides and implements the remote management request and provides such instructions for the owner or user of the vehicle to move the vehicle to one of the approved locations determined in step 202 above, if it is determined in step 210 by the call center 104 that the position of the vehicle is not one of the pre-approved locations for remote vehicle module management as determined in step 202 above.

The process then returns to step 208, and a new position of the vehicle is determined. Steps 208-212 then repeat until a determination is made in a subsequent iteration of step 210 that the position of the vehicle is an approved location for remote vehicle module management, at which point the remote management request is implemented in step 212.

It will be appreciated that certain steps or groups of steps of the remote management control process 200 may occur simultaneously and/or in a different order than that depicted in FIG. 2. For example, in certain embodiments step 208 and/or step 212 may be unnecessary. In certain other embodiments, one or more of steps 202, 204, 206, and/or 208 may occur in a different order. Also, as mentioned above, in certain embodiments the remote management request is provided only if it is determined that the vehicle is in a pre-approved location for remote management. In addition, as mentioned above, in certain embodiments various steps may be conducted by the processor 124 of FIG. 1, while in various other embodiments one or more of these steps may instead by conducted by the call center 104 of FIG. 1. Different other variations may also be implemented in connection with the steps of the remote management control process 200 of FIG. 2 and/or the order thereof.

Accordingly, improved methods, program products, and systems are provided for remotely managing modules of vehicles. The improved program methods, program products, and systems allow for vehicle modules to be remotely managed for software upgrades or updates and/or other remote management purposes without the need for the user or owner of the vehicle to take the vehicle to a service or repair facility, and while minimizing any inconvenience to the user or owner of the vehicle and/or avoiding interruptions to the remote management of the modules of the vehicle and/or the owner or user's operation of the vehicle. The improved methods, program products, and systems thereby enhance the ability to remotely manage vehicle modules while at the same time improving the experience for the user or owner of the vehicle. It will be appreciated that the improved methods, program products, and systems for remotely managing modules of vehicles that are provided herein may be utilized in any number of different types of vehicles, and for any number of different types of remote management of any number of different types of modules and/or other components of such vehicles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for remotely managing a module of a vehicle, the method comprising the steps of:
determining a position of the vehicle; and
implementing a remote management request for the module on the condition that the position of the vehicle is approved for remote management.

2. The method of claim 1, wherein the step of implementing the remote management request comprises the step of:
implementing a software update for the module on the condition that the position of the vehicle is approved for remote management.

3. The method of claim 1, wherein the step of determining the position of the vehicle comprises the step of:
determining the position of the vehicle using a global positioning system (GPS) device.

4. The method of claim 1, further comprising the step of:
determining a plurality of pre-approved locations for remote management based at least in part on historical data pertaining to driving of the vehicle, parking of the vehicle, or both;
wherein the step of implementing the remote management request comprises the step of implementing the remote management request for the module on the condition that the position of the vehicle comprises one of the plurality of pre-approved locations.

5. The method of claim 1, further comprising the step of:
determining a plurality of pre-approved locations for remote management based at least in part on a place of residence, a place of work, or both, of a user of the vehicle;
wherein the step of implementing the remote management request comprises the step of implementing the remote management request for the module on the condition that the position of the vehicle comprises one of the plurality of pre-approved locations.

6. The method of claim 1, wherein the remote management request is intended for a geographic region, and the step of implementing the remote management request comprises the step of:
implementing the remote management request for the module on the condition that the position of the vehicle is within the geographic region.

7. The method of claim 1, further comprising the step of:
notifying a user of the vehicle to take the vehicle to a pre-approved location, if the position of the vehicle is not pre-approved for remote management.

8. A program product for remotely managing a module of a vehicle, the program product comprising:
a program configured to at least facilitate:
determining a position of the vehicle; and
implementing a remote management request for the module on the condition that the position of the vehicle is approved for remote management; and
a computer-readable signal-bearing media bearing the program.

9. The program product of claim 8, wherein the program is further configured to at least facilitate implementing a software update for the module on the condition that the position of the vehicle is approved for remote management.

10. The program product of claim 8, wherein the program is further configured to at least facilitate determining the position of the vehicle using a global positioning system (GPS) device.

11. The program product of claim 8, wherein the program is further configured to at least facilitate:
determining a plurality of pre-approved locations for remote management based at least in part on historical data pertaining to driving of the vehicle, parking of the vehicle, or both; and
implementing the remote management request on the condition that the position of the vehicle comprises one of the plurality of pre-approved locations.

12. The program product of claim 8, wherein the program is further configured to at least facilitate:
determining a plurality of pre-approved locations for remote management based at least in part on a place of residence, a place of work, or both, of a user of the vehicle; and
implementing the remote management request on the condition that the position of the vehicle comprises one of the plurality of pre-approved locations.

13. The program product of claim 8, wherein:
the remote management request is intended for a geographic region; and
the program is further configured to at least facilitate implementing the remote management request on the condition that the position of the vehicle is within the geographic region.

14. The program product of claim 8, wherein the program is further configured to at least facilitate:
notifying a user of the vehicle to take the vehicle to a pre-approved location, if the position of the vehicle is not pre-approved for remote management.

15. A system for remotely managing a module of a vehicle, the system comprising:
an interface configured to at least facilitate receiving a remote management request for the module; and
a processor coupled to the interface and configured to at least facilitate:
determining a position of the vehicle; and
implementing the remote management request on the condition that the position of the vehicle is approved for remote management.

16. The system of claim 15, further comprising:
a global positioning system (GPS) device configured to provide information to the processor pertaining to a location of the vehicle;
wherein the processor is configured to at least facilitate determining the position of the vehicle based at least in part on the information.

17. The system of claim 15, wherein the processor is further configured to at least facilitate implementing a software update for the module on the condition that the position of the vehicle is approved for remote management.

18. The system of claim 15, wherein the processor is further configured to at least facilitate:
determining a plurality of pre-approved locations for remote management based at least in part on one or more of the following: historical data pertaining to driving of the vehicle, parking of the vehicle, or both, or a place of residence, a place of work, or both, of a user of the vehicle; and
implementing the remote management request on the condition that the position of the vehicle comprises one of the plurality of pre-approved locations.

19. The system of claim 15, wherein:
the remote management request is intended for a geographic region; and
the processor is further configured to at least facilitate implementing the remote management request on the condition that the position of the vehicle is within the geographic region.

20. The system of claim 15, wherein the interface is further configured to at least facilitate implementing a software update for the module on the condition that the position of the vehicle is pre-approved for remote management.
